(19) United States
(12) Patent Application Publication
(10) Pub. No.: US 2008/0173075 A1
(43) Pub. Date: Jul. 24, 2008

(54) APPARATUS AND METHOD FOR FLUID RHEOLOGY MEASUREMENTS

(76) Inventor: Steven W. Dale, Houston, TX (US)

Correspondence Address: CAROL M. NIELSEN;Baker Botts L.L.P., One Shell Plaza, 910 Louisiana Street, Houston, TX, 77002, US

(21) Appl. No.: 12/015,154

(22) Filed: Jan. 16, 2008

Related U.S. Application Data
(60) Provisional application No. 60/885,136, filed on Jan. 16, 2007.

(51) Int. Cl. G01N 11/14; G01V 1/40; E21B 47/10

(52) U.S. Cl. 73/54.31; 702/12; 73/152.18

(57) ABSTRACT

An apparatus for automated fluid rheology measurement includes a probe, a torque tube engaging an inner cylinder of the probe, a motor that drives the inner cylinder, and a circuit board programmed to drive the motor at variable shear rates in a time-dependent manner. A method of continual automated fluid rheology measurement uses an automated viscometer for measuring fluid rheology at differing shear rates. The method involves (1) obtaining and storing data at the differing shear rates, (2) calculating fluid rheology values, and repeating these steps until a user-determined endpoint.

### CROSS-REFERENCE TO RELATED APPLICATIONS

This application claims priority to U.S. Pat. App. Ser. No. 60/885,136 filed Jan. 16, 2007. Application is incorporated by reference herein in its entirety.

### FIELD OF THE INVENTION

This present invention relates generally to an apparatus and method for measuring fluid rheology.

### STATEMENT REGARDING FEDERALLY SPONSORED RESEARCH OR DEVELOPMENT

None.

### THE NAMES OF THE PARTIES TO A JOINT RESEARCH AGREEMENT

None.

### REFERENCE TO SEQUENCE LISTING

None.

### BACKGROUND OF THE INVENTION

Drilling fluids serve several functions including providing cooling and lubrication during drilling, controlling formation pressure, and suspending formation cuttings allowing them to be lifted to the surface. The suspension of formation cuttings is particularly important because it helps reduce wear on the drill bit, which is both expensive and time consuming to replace. The ability to suspend the drilling cuttings depends on the rheological properties of the drilling mud related to viscosity.

Viscosity is a property of fluids that indicates resistance to flow, and is defined as the ratio of shear stress to shear rate. Viscosity of drilling muds is determined by a couple of common techniques. The first technique employs a Marsh finnel, which is a calibrated funnel. The user must fill the funnel plugging the outlet and then manually record the time it takes for 1000 cm³ of drilling mud to flow through the funnel. The longer the time (recorded in seconds) it takes the mud to pass through the funnel, the more viscous the mud.

The second technique to measure viscosity relies on determining properties of the fluid under variable shear conditions. The plastic viscosity (PV) indicates the flow characteristics of the mud when it is moving rapidly, and the yield point (YP) indicates the flow characteristics when the mud is moving relatively slowly or at rest. In both cases, higher values indicate a more viscous mud. PV and YP are generally measured using specific standards in the drilling industry. In order to obtain values for these properties several measurements must be taken under variable shear conditions. In the field, this generally involves manually increasing the motor speed of a viscometer and recording values at the different speeds (most frequently 30, 60, 300, and 600 rpm).

During the drilling process, the composition of the drilling mud may need to be monitored and altered frequently, according to current drilling conditions. Changes in mud viscosity are critical when drilling deviated and horizontal wellbores. Therefore, a method that facilitates taking such measurements rapidly, without the need for manual operation of equipment would be beneficial.

### SUMMARY OF THE INVENTION

In some aspects, the invention relates to an apparatus for automated fluid rheology measurement including a probe, a torque tube engaging an inner cylinder of the probe, a motor that drives the inner cylinder, and a circuit board programmed to drive the motor at variable shear rates in a time-dependent manner.

The present invention also relates to a method of continual automated fluid rheology measurement by providing an automated viscometer for measuring fluid rheology at differing shear rates. The method involves (1) obtaining and storing data at the differing shear rates, (2) calculating fluid rheology values, and repeating these steps until a user-determined endpoint.

Advantageously, the present invention provides a means of automated measurement of drilling fluid rheology obviating the need for manual operation of equipment and minimizing down time in the drilling process.

The foregoing has outlined rather broadly the features of the present invention in order that the detailed description of the invention that follows may be better understood. Additional features and advantages of the invention will be described hereinafter, which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is an automated viscometer for measuring fluid rheology.

FIG. 2 is a chart depicting electronic controls within the viscometer apparatus.

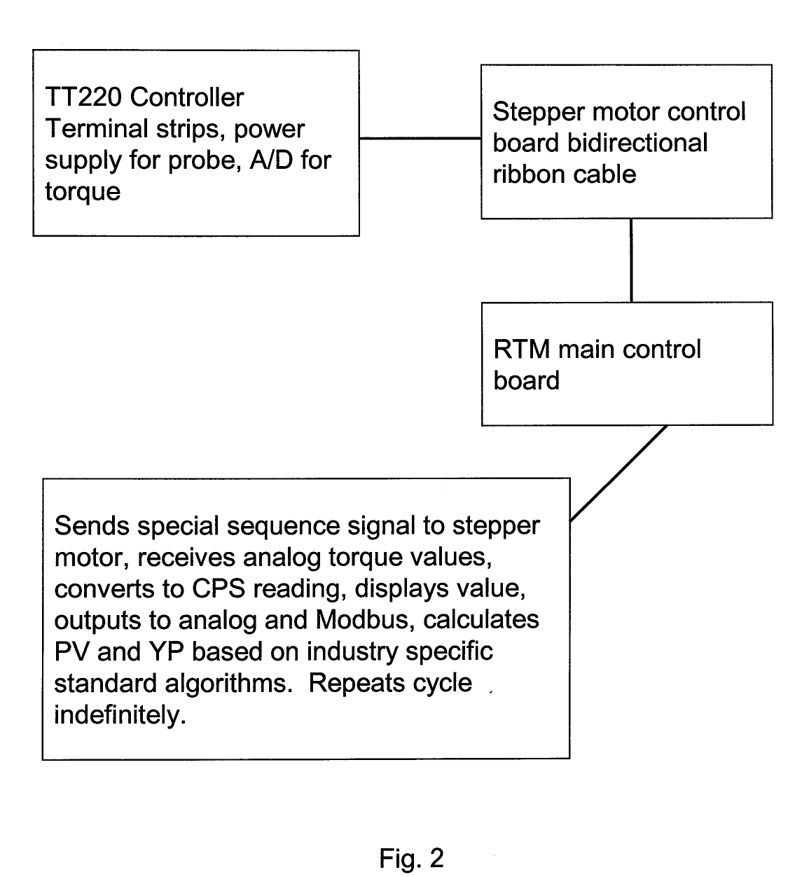

FIG. 3 is one embodiment of the viscometer apparatus.

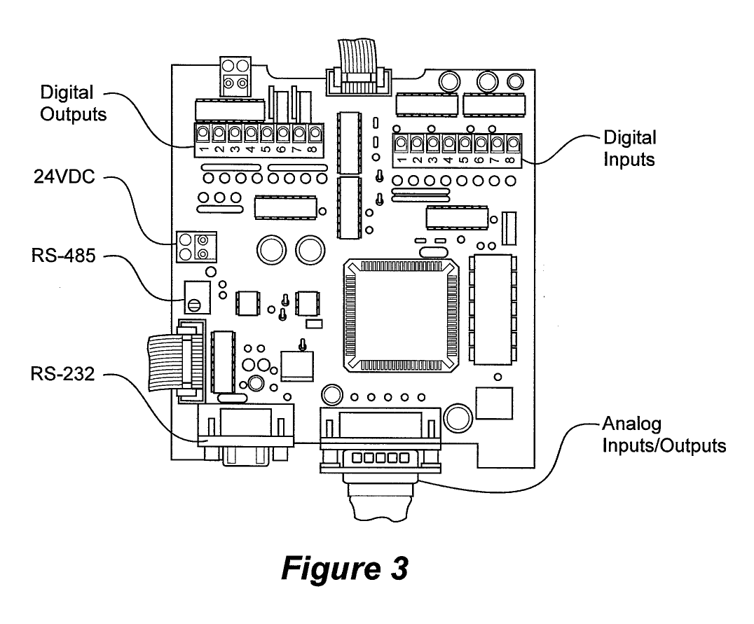

### DESCRIPTION OF THE INVENTION

In the following description, specific details are set forth such as specific quantities, sizes, etc. so as to provide a thorough understanding of embodiments of the present invention. However, it will be obvious to those skilled in the art that the present invention may be practiced without such specific details. In many cases, details concerning such considerations and the like have been omitted inasmuch as such details are not necessary to obtain a complete understanding of the present invention and are within the skills of persons of ordinary skill in the relevant art.

Referring to the drawings in general, it will be understood that the illustrations are for the purpose of describing a particular embodiment of the invention and are not intended to limit the invention thereto.

The present invention generally provides an apparatus and method for the measurement of viscosity of drilling fluid while in surface tanks (e.g. mud pits). A source of power is connected to a Searle type or Couette type viscometer that rotates at industry specific defined shear rates. The measurement of shear stress and shear rate may be transmitted to a control unit which then calculates viscosity (CPS), plastic viscosity (PV), and yield point (YP) in accordance with industry practice. The apparatus may be designed to run continuously in the various tanks which contain a drilling fluid system providing real time measurement of viscosity properties of the drilling fluid and displaying such measurements by LED or LCD screen with appropriate digital and analog outputs for communicating with external devices.

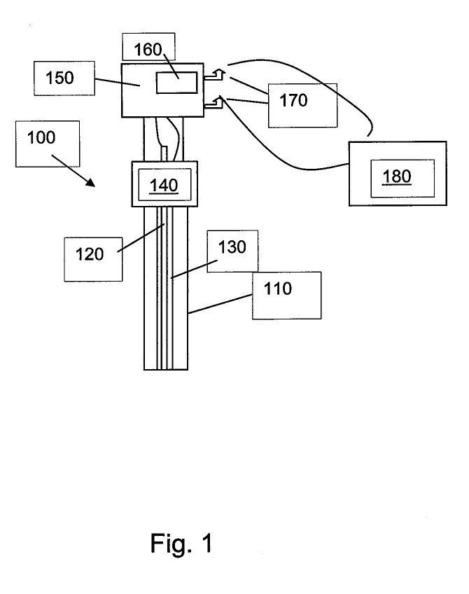

With reference to FIG. 1, an apparatus for automated fluid rheology measurement 100 includes, but is not limited to a probe 110, a torque tube 120 engaging an inner cylinder 130 of probe 110, a motor 140 that drives inner cylinder 130, and a circuit board 150 (generically encased in a housing) programmed to drive motor 140 with differing shear rates in a time-dependent manner. Although FIG. 1 shows, in a generic sense, the use of hardwired circuitry to drive the motor, other means for driving the motor through software with a computer may also be beneficial.

Probe 110 may be any of several designs that allows fluid flow through industry specific annular spaces. When using the Searle design, speeds may be adjusted to allow shear rate matching with the industry standard. When using the Couette geometry, speeds may also be adjusted to allow shear rate matching with the industry standard. Probe 110 may be mounted in a sampling area, such as in a mud return area or mud pit supply, for example. Probe 110 may further be equipped with an adjustable flow restriction device to allow mounting in turbulent and calm areas of the tanks. The probe may also be equipped with a means to adjust immersion depth as necessary for in situ continuous measurement.

Probe 110 is controlled by a stepper motor 140 and coupled with a torque sensing system (torque tube 120) that has dimensions that closely duplicate the annulus and length required to generate standardized shear rates. A data collection system for fluid rheology measurements of drilling fluids therefore includes a data collection logic device as part of circuit board 150 configured to collect information pertaining to rheology measurements. These measurements are transmitted by an electronic signal generated from torque tube 120, which is part of a the torque sensing system coupled to probe 110. Probe 110 is driven in a time-dependent manner by a stepper motor (motor 140) controlled by the same data collection logic device.

Circuit board 150 is programmed to drive motor 140 in discreet steps or speeds according to industrial standards for viscosity measurements. Upon turning the machine on, the hardwired circuit board is designed to start the motor speed at 30 rpm. After a fixed period of time measurement at 30 rpm viscosity data is recorded and the motored stepped up to 60 rpm. The process of recording data measurements and stepping through motor speeds continues through 300 rpm and finally 600 rpm.

The stored data at each speed is then used to calculate at least one fluid rheology measurement. Such measurement may include, for example, the viscosity, plastic viscosity (PV), and yield point (YP). Mathematical models used to calculate PV and YP are industry specific and can be modified according to the changing needs of the industry. Several new standards are under consideration including using the Herschel-Bulkley and Power Law formulas to monitor N (prime) and K (prime) values. The system may be flexible to allow these changes.

Once the data is processed it may be displayed locally on the viscometer on an LED or LCD display 160. Such displays may be multi-lined to provide the relevant data in a single display. Alternatively, the circuit board may be equipped with digital and or analog output 170 for integration with a remote display monitor 180. All calculated PV and YP measurements may be stored in a memory device for later retrieval, as deemed necessary. Circuit board 150 drives the motor in iterable cycles, thus once the calculations have been performed and PV and YP measurements displayed and/or stored, the motor speed is stepped back down to 30 rpm and the process repeated until the machine is turned off.

In operation, an automated viscometer may be used for continual rheology measurement. The automated viscometer operates by immersing the viscosity probe directly into the mud tanks, obviating the need to draw off samples and test them in a separate location. Alternatively the probe can be installed directly into the suction or supply side of the pump system on the rig.

The automated viscometer described above may be used to obtain and store data at differing shear rates to allow the calculation of PV and YP repeatedly over the time of drilling until the user determines that the viscometers is no longer needed and it is turned off. Otherwise the viscometer is designed to continually run through the sequence of rheology measurements at 30, 60, 300, and 600 rpm.

A method in a computer data collection system for measuring fluid rheology of drilling fluid may include detecting viscosity from a probe placed in a drilling fluid. The probe may be driven by a stepper motor. As described above such functions may be hardwired into a pre-programmed circuit board. Alternatively, the above described programmed sequences may be driven by software with the aid of a computer interface. Indeed, a remote display of the collected data may be provided remote from the site of the installed automated viscometer.

A method for analyzing viscosity measurements of drilling fluids includes, but is not limited to collecting a plurality of torque sensitive measurements of viscosity at differing shear rates in a time-dependent manner and calculating plastic viscosity and yield point from these measurements at the differing shear rates. Again a means for remotely displaying and storing the calculated plastic viscosity and yield point may be provided. Thus, the automated viscometer should be equipped with the ability to transmit data via analog, digital, or combinations thereof.

The calculated rheology values may be sent in the form of a signal to change mud composition to a source. The source that alters the mud composition may be a human user. Alternatively, the source may itself be an apparatus for automatically altering mud composition. Thus, the entire process of detecting drilling mud viscosity and responding to necessary changes in viscosity may be automated.

Advantageously, the present invention provides an apparatus and method for continual automated measurement of fluid rheology without the need for constant sampling and manual manipulation of equipment. Thus, rapid response may be made to changes in drilling conditions while drilling is in process and down time may be minimized.

### EXAMPLE 1

### Viscometer—Modbus Mapping

| | | AI - | AI - | | | | | |
|---|---|---|---|---|---|---|---|---|
| | | Low | High | Seconds | Raw | Scaled | | |
| | RPM | Scale | Scale | at Speed | AI | AI | PV | YP |
| Speed 1 | 41001 | 41002 | 41003 | 41004 | 41006 | 41007 | | |
| Speed 2 | 41011 | 41012 | 41013 | 41014 | 41016 | 41017 | | |
| Speed 3 | 41021 | 41022 | 41023 | 41024 | 41026 | 41027 | | |
| Speed 4 | 41031 | 41032 | 41033 | 41034 | 41036 | 41037 | 41038 | 41039 |
| Temperature | | 41042 | 41043 | | 41046 | 41047 | | |
| (Optional) | | | | | | | | |

| | Sequence | | | Current | |
|---|---|---|---|---|---|
| | Counter | Current | Run/ | Raw AI - | Current |
| | (Sec) | Speed | Stop | Torque | RPM |
| Other | 41051 | 41052 | 41053 | 41054 | 41055 |

### EXAMPLE 2

### Key Map

| | F1 | F2 | F3 | F4 |
|---|---|---|---|---|
| Run Mode | Config Mode (5 Sec) | Run | Stop | Version Display (5 sec) |
| Config Mode | Back to Run Mode | Prev Parm | Next Parm | Save Mode (5 Sec) |

| | | | |
|---|---|---|---|
| Save Mode | Back to Run Mode | BOTH KEYS - Clear | Save Config to |
| | | EEPROM (5 sec) | EEPROM |

### EXAMPLE 3

### Wiring—TB in Viscometer Enclosure Controller Cable Connects to Enclosure TB

| | | Switch Wire | Stepper | Controller | Controller TB |
|---|---|---|---|---|---|
| | Switch | Color | Board | Cable | (Output) |
| Enclosure TB | None | | | | |
| Position 1 | | | | | |
| Enclosure TB | Stay | Black | NA | NA | NA |
| Position 2 | Connected | | | | |
| Enclosure TB | Speed 4 | Yellow | Port 4 | Grey | Pin 6 |
| Position 3 | | | | | |
| Enclosure TB | Run | Black (I) | Go | Orange | Pin 1 |
| Position 4 | | | | | |
| Enclosure TB | Stop | Black (II) | Stop | Brown | Pin 2 |
| Position 5 | | | | | |
| Enclosure TB | Stay | Black (2 Wires) | GND | NA | NA |
| Position 6 | Connected | | | | |
| Enclosure TB | Speed 1 | Red | Port 1 | Purple | Pin 3 |
| Position 7 | | | | | |
| Enclosure TB | Speed 3 | Orange | Port 3 | Yellow | Pin 5 |
| Position 8 | | | | | |
| Enclosure TB | Stay | Red | +5 V | NA | NA |
| Position 9 | Connected | | | | |
| Enclosure TB | Speed 2 | Brown | Port 2 | Blue | Pin 4 |
| Position 10 | | | | | |

### EXAMPLE 4

### Wiring—TB in Viscometer Enclosure Controller Cable Connects to Switch Wires (Lugs) Removed from TB

| | | Switch | Controller | Controller |
|---|---|---|---|---|
| | Switch | Wire Color | Cable | TB (Input) |
| Enclosure TB | NA | | | |
| Position 1 | | | | |
| Enclosure TB | NA | NA | NA | NA |
| Position 2 | | | | |
| Enclosure TB | NA | NA | NA | NA |
| Position 3 | | | | |
| Enclosure TB | Run | Black (I) | Blue (External) | Pin 2 |
| Position 4 | | | | |
| Enclosure TB | Stop | Black (II) | Black | Pin 1 |
| Position 5 | | | | |
| Enclosure TB | NA | Black (2 Wires) | NA | NA |
| Position 6 | | | | |
| Enclosure TB | NA | NA | NA | NA |
| Position 7 | | | | |
| Enclosure TB | NA | NA | NA | NA |
| Position 8 | | | | |
| Enclosure TB | NA | NA | NA | NA |
| Position 9 | | | | |
| Enclosure TB | NA | NA | NA | NA |
| Position 10 | | | | |

### EXAMPLE 5

### Analog Inputs 15 Pin D Shell Connector

| | Range | Pins | Analog Ground |
|---|---|---|---|
| AI 1 (Torque AI) | 0 to 5 V | Pin 8 | Pin 9, 10, 11 |
| AI 2 (Temperature AI) - | 0 to 5 V | Pin 7 | Pin 9, 10, 11 |
| OPT | | | |
| AO 1 - OPT | 0 to 5 V | Pin 1 | Pin 9, 10, 11 |

### EXAMPLE 6

### Default Settings

| | | AI - Low | AI - High | Seconds at |
|---|---|---|---|---|
| | RPM | Scale | Scale | Speed |
| Speed 1 | 30 | 0 | 4000 | 120 |
| Speed 2 | 60 | 0 | 2000 | 120 |
| Speed 3 | 300 | 0 | 400 | 120 |
| Speed 4 | 600 | 0 | 200 | 120 |
| Temperature | NA | 0 | 0 | NA |
| (Optional) | | | | |
| ComM 1 (RS-232) | 38400, 8, N, 1 | | | |
| Comm 3 (RS-485) | 9600, 8, N, 1 | | | |

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed:

1. An apparatus for automated fluid rheology measurement comprising:
a viscometer probe;
a torque tube engaging an inner cylinder of the viscometer probe;
a motor;
wherein the motor drives the inner cylinder; and
a means for driving the motor at variable speeds in a time-dependent and automated manner.

2. The apparatus of claim 1, wherein the circuit board is further programmed to receive data from the torque tube.

3. The apparatus of claim 2, wherein said data is used to calculate at least one fluid rheology measurement.

4. The apparatus of claim 3, wherein the at least one fluid rheology measurement is the yield point.

5. The apparatus of claim 3, wherein the at least one fluid rheology measurement is the plastic viscosity.

6. The apparatus of claim 1, wherein the circuit board drives the motor in iterable cycles.

7. The apparatus of claim 6, wherein the iterable cycles comprise motor speeds of 30 rpm, 60 rpm, 300 rpm, and 600 rpm.

8. The apparatus of claim 1, further equipped with a data display monitor.

9. The apparatus of claim 1, further equipped with means for transmission of data to a remote display monitor.

10. The apparatus of claim 1, further equipped with a data storage means.

11. A method of continual automated fluid rheology measurement comprising:
(a) providing an automated viscometer for measuring fluid rheology at differing shear rates;
(b) obtaining and storing data at the differing shear rates;
(c) calculating fluid rheology values; and
(d) repeating steps (b) and (c) until a user-determined endpoint.

12. The method of claim 11, wherein the automated viscometer has a circuit board programmed to receive data at the differing shear rates.

13. The method of claim 12, wherein said data is used to calculate at least one fluid rheology measurement.

14. The method of claim 12, wherein the at least one fluid rheology measurement is the yield point.

15. The method of claim 12, wherein the at least one fluid rheology measurement is the plastic viscosity.

16. The method of claim 12, wherein the circuit board drives a motor in iterable cycles.

17. The method of claim 16, wherein the iterable cycles comprise motor speeds of 30 rpm, 60 rpm, 300 rpm, and 600 rpm.

18. The method of claim 11, further comprising displaying fluid rheology values on a data display monitor.

19. The method of claim 18, wherein the data display monitor is remote relative to the automated viscometer.

20. The method of claim 11, further comprising using the calculated rheology values to send a signal to change mud composition to a source.

21. The method of claim 20, wherein the source that alters the mud composition is a human user.

22. The method of claim 20, wherein the source is an apparatus for automatably altering mud composition.

23. A data collection system for fluid rheology measurements of drilling fluids comprising a data collection logic device configured to collect information pertaining to said rheology measurements, said measurements are transmitted by an electronic signal generated from a torque sensing system coupled to a probe;
wherein in said probe is driven in a time-dependent manner by a stepper motor controlled by said data collection logic device.

24. A method in a computer data collection system for measuring fluid rheology of drilling fluid comprising detecting viscosity from a probe placed in a drilling fluid;
wherein said probe is driven by a stepper motor.

25. A method for analyzing viscosity measurements of drilling fluids comprising:
collecting a plurality of torque sensitive measurements of viscosity at differing shear rates in a time-dependent manner; and
calculating plastic viscosity and yield point from said measurements of viscosity at said differing shear rates.

26. The method of claim 24, further comprising providing a means for remotely displaying and storing said calculated plastic viscosity and said yield point.

27. In an apparatus for measuring drilling fluid composition having a viscometer probe, a torque tube engaging an inner cylinder of the viscometer probe, and a motor, wherein the motor drives the inner cylinder, the improvement comprising a means for driving the motor at variable speeds in a time-dependent and automated manner to produce a series of plastic viscosity and yield point measurements useful in determining whether adjustment is required in the composition of the drilling fluid.
